(19) United States
(12) Patent Application Publication
(10) Pub. No.: US 2009/0044253 A1
(43) Pub. Date: Feb. 12, 2009

(54) Managing unprotected and protected content in private networks

(75) Inventors: Antony Interlandi, Victoria (AU); Stephen Harper, Victoria (AU); Dominic Cannalonga, Victoria (AU)

Correspondence Address: SEED INTELLECTUAL PROPERTY LAW GROUP PLLC, 701 FIFTH AVE, SUITE 5400, SEATTLE, WA, 98104, US

(73) Assignee: Now Technologies Pty Limited, Lower Templestowe, Victoria (AU)

(21) Appl. No.: 11/792,175

(22) PCT Filed: Dec. 2, 2005
(86) PCT No.: PCT/AU2005/001824

§ 371 Date: Jul. 18, 2008

(30) Foreign Application Priority Data
Dec. 2, 2004 (AU) 2004906908
Jan. 25, 2005 (AU) 2005900320

(51) Int. Cl. G06F 21/00

(52) U.S. Cl. 726/4

(57) ABSTRACT

A method for managing unprotected and protected content in a private network, the method including the steps of: receiving content; retrieving metadata associated with the received content; determining whether the received content is unprotected or protected based on the associated metadata; for unprotected content, allowing the unprotected content to be selectively stored, managed and distributed in the private network based on the associated metadata; for protected content, identifying a content protection system associated with the protected content based on the associated metadata, and performing at least one of: displaying information to a user of the private network facilitating retrieval of one or more hardware/software components required by the associated content protection system; retrieving the one or more required hardware/software components; verifying that the one or more required hardware/software components are present in the private network, before allowing the protected content to be selectively stored, managed and distributed in the private network based on the associated metadata.

### FIELD OF THE INVENTION

The present invention relates to managing unprotected and protected content in private networks.

### BACKGROUND OF THE INVENTION

Content providers employ a wide variety of content protection systems to control access to content. Content protection systems include digital rights management (DRM) systems, copy protection (CP) systems, conditional access (CA) systems, technical protection measures (TPM), etc. Content protection systems generally require hardware/software components to be present within private networks before protected content can be accessed by users.

Navigating the subtleties and complexities of content protection systems presents problems to users who wish to store, manage and distribute content in private networks. Content users may not even know there are content protection systems, what they are, and how they work in private networks. These problems are compounded because different content providers employ different content protection systems that are not interoperable.

A need therefore exists for an integrated solution for managing unprotected and protected content in private networks.

### SUMMARY OF THE INVENTION

According to the present invention, there is provided a method for managing unprotected and protected content in a private network, the method including the steps of:
receiving content;
retrieving metadata associated with the received content;
determining whether the received content is unprotected or protected based on the associated metadata;
for unprotected content, allowing the unprotected content to be selectively stored, managed and distributed in the private network based on the associated metadata;
for protected content, identifying a content protection system associated with the protected content based on the associated metadata, and performing at least one of:
   displaying information to a user of the private network facilitating retrieval of one or more hardware/software components required by the associated content protection system;
   retrieving the one or more required hardware/software components;
   verifying that the one or more required hardware/software components are present in the private network,
before allowing the protected content to be selectively stored, managed and distributed in the private network based on the associated metadata.

The present invention also provides a processor program product stored in a processor readable storage device, the processor program product having processor instructions for causing at least one processor to:
receive content;
retrieve metadata associated with the received content;
determine whether the received content is unprotected or protected based on the associated metadata;
for unprotected content, allow the unprotected content to be selectively stored, managed and distributed in the private network based on the associated metadata;
for protected content, identify a content protection system associated with the protected content based on the associated metadata, and perform at least one of:
   display information to a user of the private network facilitating retrieval of one or more hardware/software components required by the associated content protection system;
   retrieve the one or more required hardware/software components;
   verify that the one or more required hardware/software components are present in the private network,
before the protected content is allowed to be selectively stored, managed and distributed in the private network based on the associated metadata.

The present invention further provides a system for managing unprotected and protected content in a private network, the system including:
one or more processors connected to the private network;
processor instructions for causing the one or more processors to:
   receive content;
   retrieve metadata associated with the received content;
   determine whether the received content is unprotected or protected based on the associated metadata;
   for unprotected content, allow the unprotected content to be selectively stored, managed and distributed in the private network based on the associated metadata;
   for protected content, identify a content protection system associated with the protected content based on the associated metadata, and perform at least one of:
      display information to a user of the private network facilitating retrieval of one or more hardware/software components required by the associated content protection system;
      retrieve the one or more required hardware/software components;
      verify that the one or more required hardware/software components are present in the private network,
   before the protected content is allowed to be selectively stored, managed and distributed in the private network based on the associated metadata; and
one or more processor readable storage devices connected to the one or more processors to store the processor instructions, the received content, the associated metadata and the one or more hardware/software components required by the associated content protection system.

### BRIEF DESCRIPTION OF THE DRAWINGS

Embodiments of the present invention will now be described solely by way of non-limiting examples and with reference to the accompanying drawings in which:

FIG. 1 is a schematic component diagram of a system for managing unprotected and protected content in a private network according to an embodiment of the present invention;

FIG. 2 is a flowchart of a method for managing unprotected and protected content in a private network according to an embodiment of the present invention;

FIGS. 3A-N are example screenshots of management of stored content; and

FIGS. 4A-I are example screenshots of playlists of stored content.

### DETAILED DESCRIPTION OF THE EMBODIMENTS

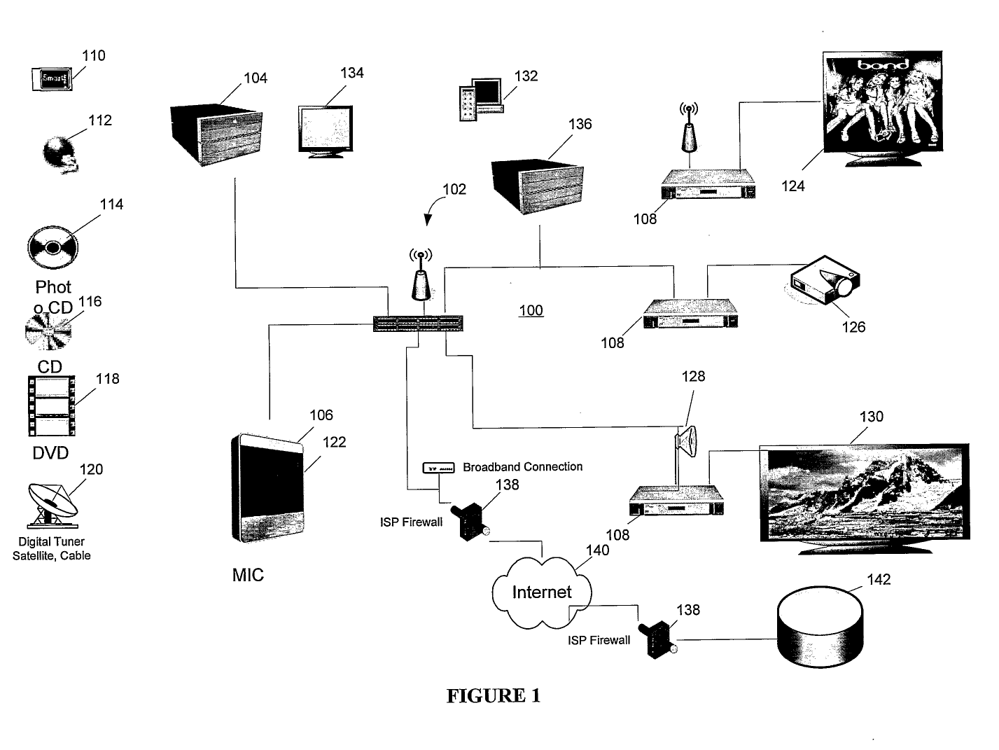

FIG. 1 is a component diagram of a distributed and scalable system 100 for managing unprotected and protected content. The system 100 is connected to a wired and/or private network 102 in a private environment, for example, a home environment. The private network 102 can be, for example, an Intranet, a cellular network, a local area network (LAN), a virtual private network (VPN), a personal area network (PAN), an authorised domain (AD) etc, in private user environments, for example, private vehicles, private businesses, private premises, etc.

Content, for example, digital video, digital audio, digital photos, digital graphics, digital animation, digital text, digital multimedia, etc is received into the private network 102 by a server 104 and distributed clients 106, 108 connected to the private network 102. Content can be received from, for example, memory cards 110, Internet connections or website links 112, photo CDs 114, music CDs 116, DVDs 118, satellite downlinks 120, digital tuners, cable networks, etc. Content can also be received from other sources, for example, devices such as tuner/decoders and set-top boxes, public networks such as cellular networks and cable television networks, mobile terminals such as mobile telephones, media players such as MP3 players, game consoles, and portable computing devices such as personal digital assistants (PDAs).

Client 106 is a content reception and user interface node of the private network 102. The client 106 includes a DVD/CD drive, a memory card slot and connections for other sources of content discussed above. The client 106 also includes a touch screen display 122 for user interface to the system 100. Clients 108 are content distribution nodes of the private network 102 that distribute and render content to playback/rendering devices, for example, plasma display 124, projector 126, sound system 128, and LCD display 130. The clients 108 also include a DVD/CD drive and a memory card slot to receive content. Remote control devices 132 are provided for integrated user control of the system 100.

The server 104 is a content storage and management node of the private network 102 and is programmed with content management software for managing unprotected and protected content. The server 104 also includes a DVD/CD drive, a memory card slot and connections for other sources of content discussed above. A touch screen display 134 associated with the server 104 also provides user interface to the system 100.

A physical media storage device 136 connected to the private network 102 is a content protection and verification node of the private network 102. The physical media storage device 136 physically stores removable storage media, for example, music CDs 116 and DVDs 118 associated with content protection systems, for example, digital rights management (DRM) systems, copy protection (CP) systems, conditional access (CA) systems and technical protection measures (TPM). The physical media storage device 136 also stores software components associated with content protection systems, for example, encryption/decryption keys, digital licenses, digital certificates, digital watermarks, product registrations, user registrations, activation codes, subscriptions, digital signatures, device IDs and user IDs. The physical media storage device 136 is also a bulk loading device to scalably handle n number of storages, management and content verifications with no user interaction. A log of all stored and managed content is provided to the user on request or completion of content verification and/or use. Additional physical media storage devices 136 (not shown) can be connected to the private network 102 to provide scalable content protection and verification functionality. In addition, content protection hardware/software components can also be stored in the server 104.

The system 100 is connectable via firewalls 138 and the Internet 140 to web server 142. The web server 142 provides content metadata, software updates and remote configuration for the system 100.

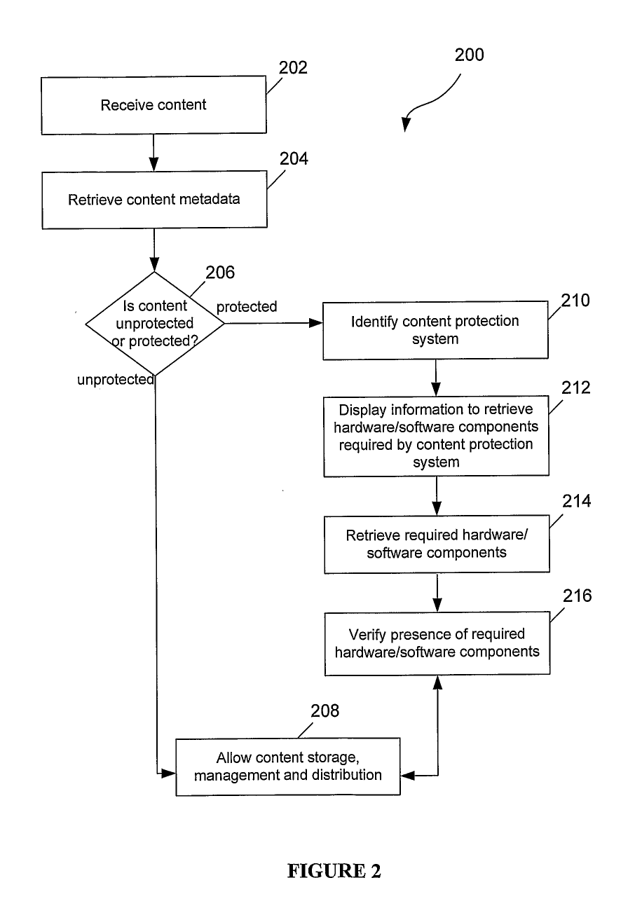

FIG. 2 is a flowchart illustrating a process 200 for managing unprotected and protected content performed by the system 100. Upon receipt of content in the private network (step 202), metadata associated with the received content is retrieved (step 204) from, for example, content itself, public networks, remote databases, local databases, metadata providers and users of the private network. The retrieval of metadata for example types of content is discussed in detail below. After the associated metadata is retrieved, a determination is made whether the received content is unprotected or protected based on the associated metadata (step 206). Unprotected content can then be freely and selectively stored, managed and distributed in the private network based on the associated metadata (step 208). On the other hand, the associated metadata is used to identify content protection systems associated with protected content (step 210). Content protection systems associated with protected content include, for example, digital rights management (DRM) systems, copy protection (CP) systems, conditional access (CA) systems, technical protection measures (TPM), etc.

Once an associated content protection system is identified, information is displayed to users of the private network to facilitate retrieval of hardware/software components required by the associated content protection system (step 212). Further or alternatively, information relating to required hardware/software components and/or content protection systems cans be logged for review by user on request. Hardware/software components required by associated content protection systems are retrieved from, for example, the content itself, public networks, local databases, remote databases, content providers, storage media, storage devices and users of the private network. Required hardware/software components include, for example, storage media, storage devices, smartcards, dongles, encryption/decryption keys, digital licenses, digital certificates, digital watermarks, media players, product registrations, user registrations, activation codes, subscriptions, digital signatures, device IDs, user ID, etc. Content protection systems can require different combinations of two or more hardware/software components to be present in the private network, for example, MP3 DRM systems can require the presence of portable MP3 media players and MP3 DRM software. The nature and extent of access to protected content in the private network can be based at least in part on required hardware/software components. The required hardware/software components are retrieved (step 214) and/or verified as present in the private network (step 216). Thereafter, protected content can be selectively stored, managed and distributed in the private network based on the associated metadata (step 208).

Software executed by the server 104 and/or the physical media storage device 136 verifies that required hardware/software components are present in the private network 102. The required hardware/software components can be stored in the server 104 and/or the physical media storage device 136 for subsequent retrieval and/or verification. The server 104 and/or the physical media storage device 136 can be programmed to detect whether required hardware components, for example, portable media players, dongles, etc, are connected to the private network 102 either directly or indirectly via the components of the system 100.

The associated metadata can be retrieved from content sources, for example, CDs can be identified by metadata such as their table of contents (TOC). This binary structure is converted into a hexadecimal string and is submitted as part of a metadata query to a metadata database, for example the metadata database on the web server 140. The queried metadata database then returns a set of unique id strings which are concatenated to produce metadata to identify CDs. The id strings are stored in a local database, for example in the server 104, to identify the CDs. Photo CDs can be identified by, for example, their volume name. The volume name is retrieved using, for example, the Windows (trade mark) 32 API function GetVolumeInformation.

Metadata associated with DVDs can be retrieved based on three separate identifiers. When a DVD is first added to the system 100, the Microsoft (trade mark) DirectX interface IDVDInfo2 obtains a system generated 64 bit number for the DVD. A metadata database, for example on the web server 142, is then searched for a matching entry. If a record is not found in the metadata database, a unique product code (UPC) is read from the DVD disc. If this cannot be found, the user is prompted to input the UPC which is normally found on the rear cover as a barcode. A metadata database is then queried using the UPC to obtain information and cover art for the DVD. The metadata database also returns a Disc ID which is stored in the database on the server 104 together with the UPC. The Microsoft (trade mark) ID is used as the key when the DVD is stored in the server 104. When the DVD is put into the DVD drive again, the Microsoft (trade mark) ID is used to look up the record in the server 104. Other suitable methods for identifying DVDs will be apparent to those skilled in the art.

The metadata associated with content includes, for example, titles, poster or cover art, audio and/or video clips, summaries, authors, performers, producers, genres, ratings, versions, reviews, etc. For DVDs and CDs, the metadata is retrieved from metadata providers. For digital television or radio broadcasts, the metadata may include, for example, electronic program guides (EPGs). Further or alternatively, metadata associated with received content can be retrieved from users of the private network via user interfaces 122, 134.

Content can be stored in its native or original format in a database on the server 104 to optimise playback or rendering. Alternatively, content can be stored in compressed format. The associated metadata can also be stored in the database in the server 104. Supported photo formats are detected by extension and signature bytes within the file. Each valid file is then copied to the target directory in the server 104 using operating system file copy operations. During the copy process, the photo resolution is tested and down scaled to fit into the maximum rendering resolution of the playback devices 108 thereby allowing for any stored image resolution to be displayed to playback or rendering devices 122, 124, 126, 128.

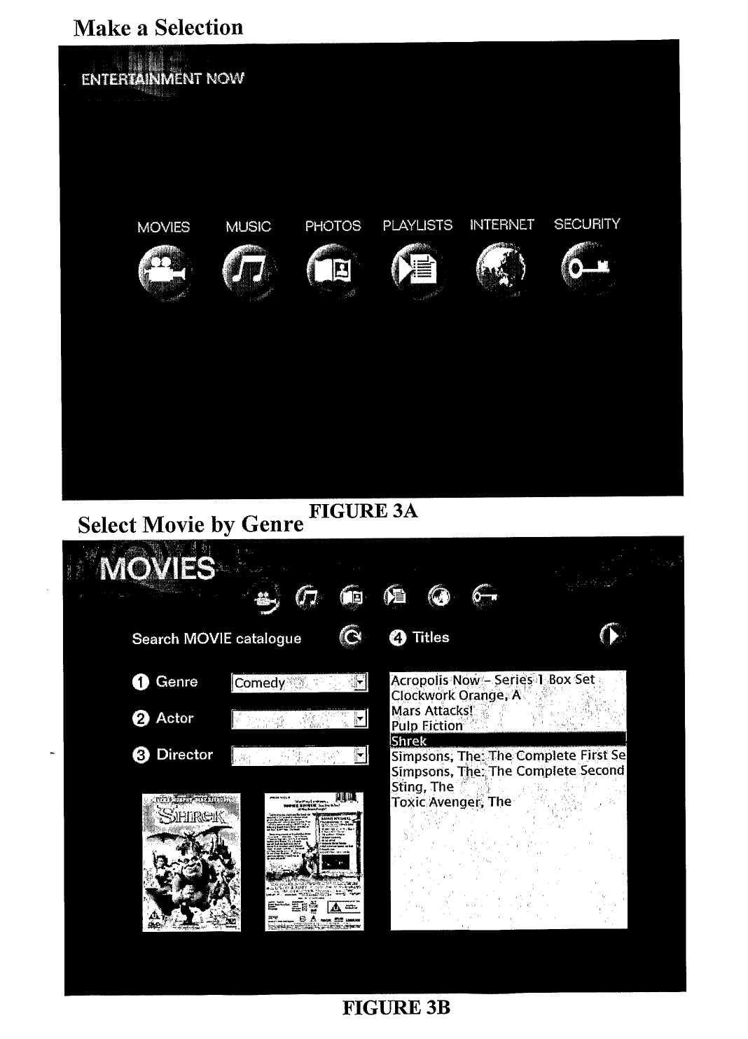

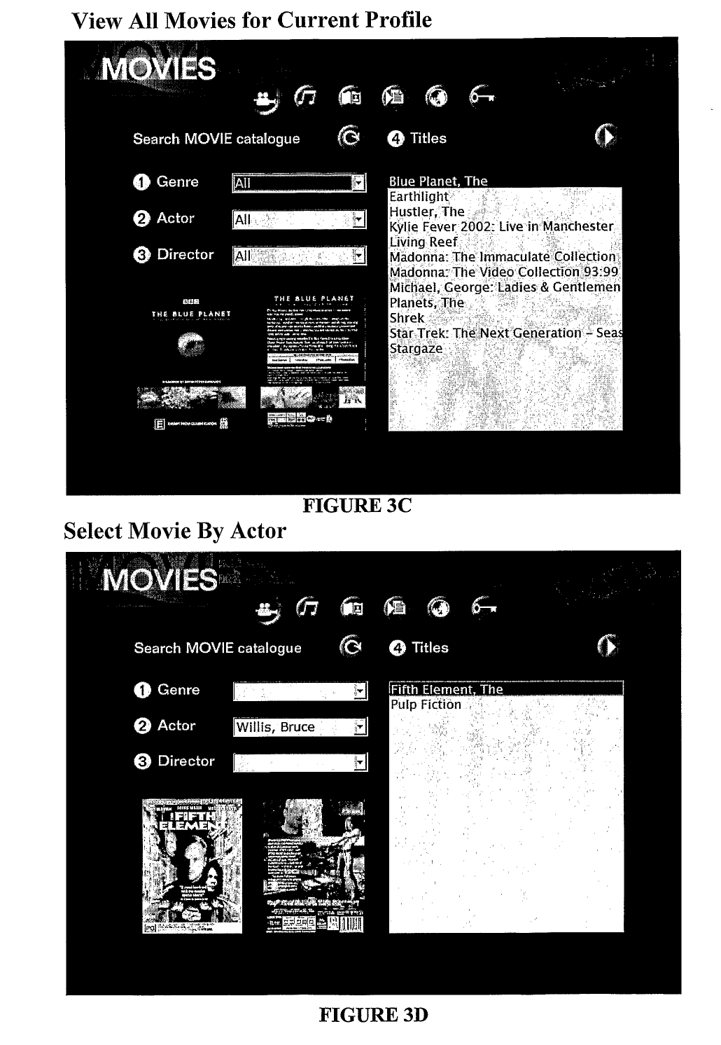

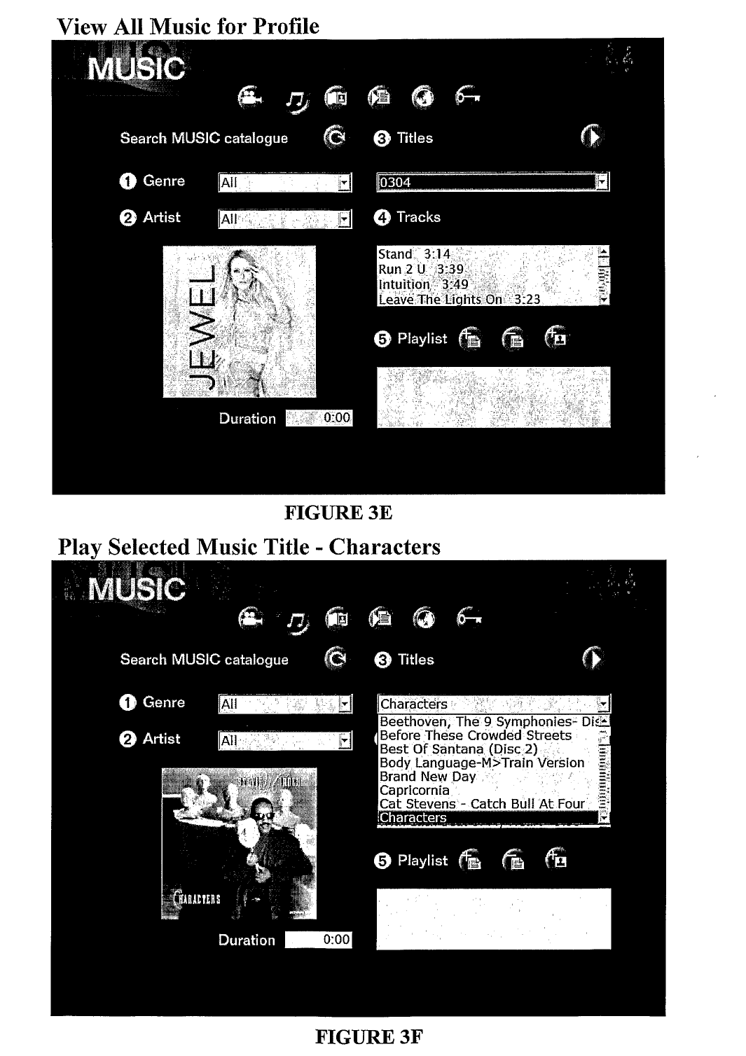

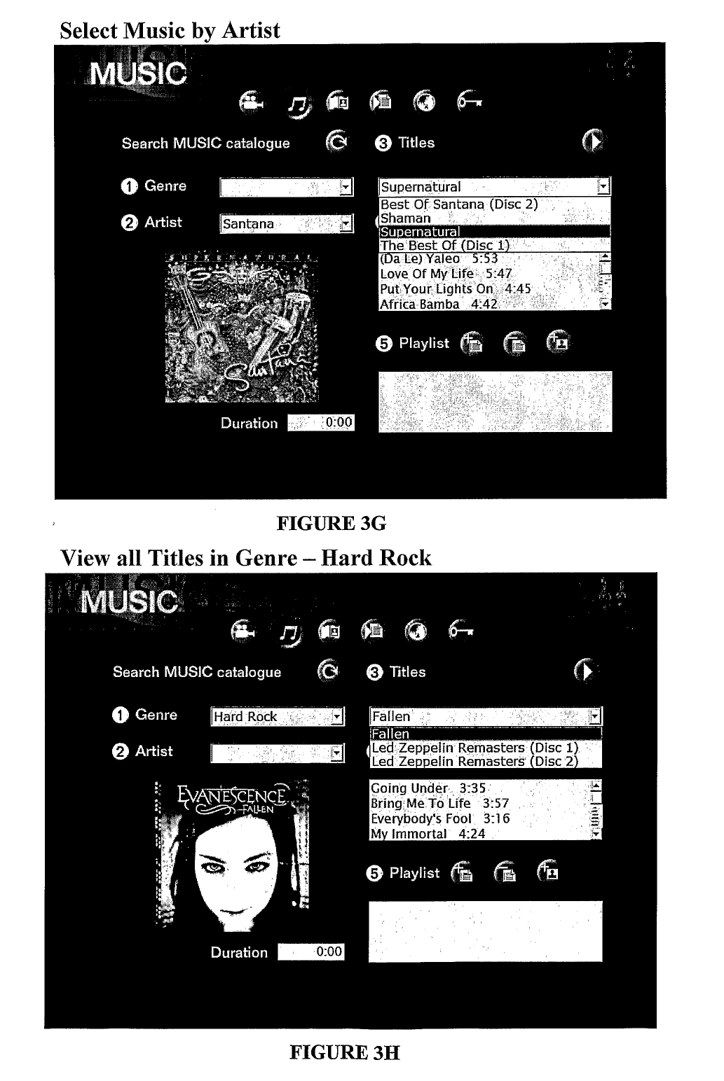

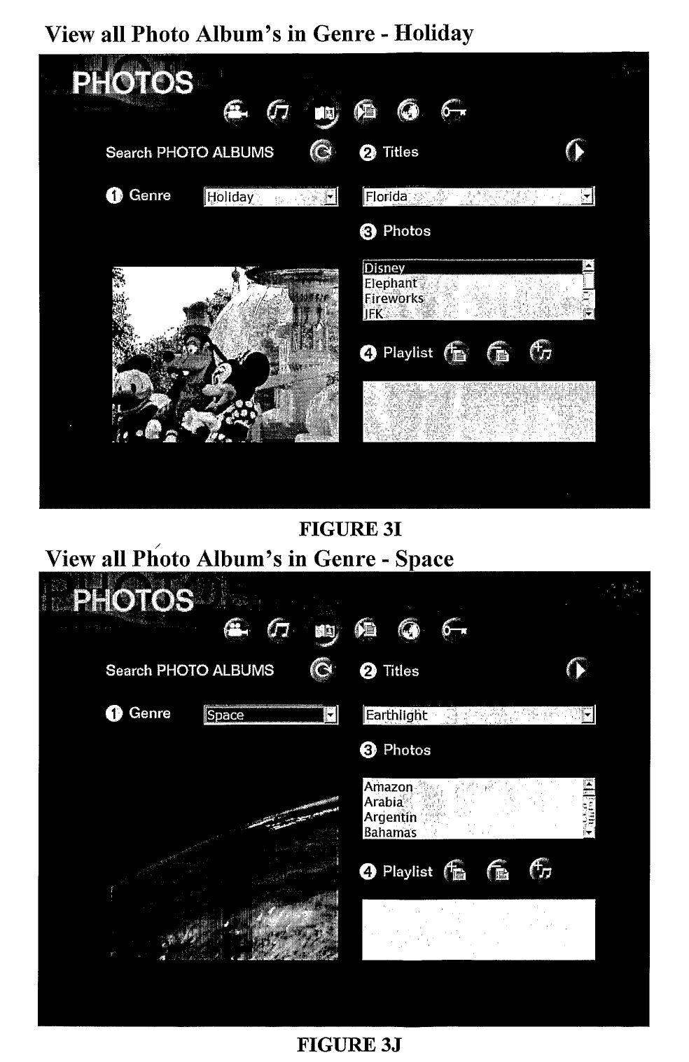

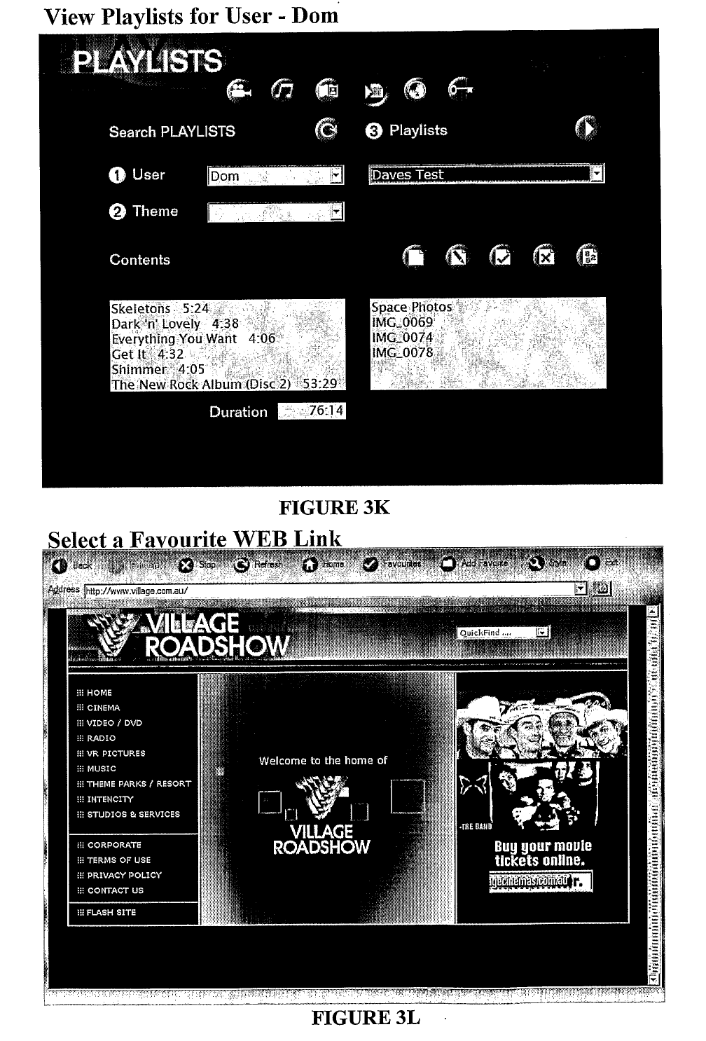

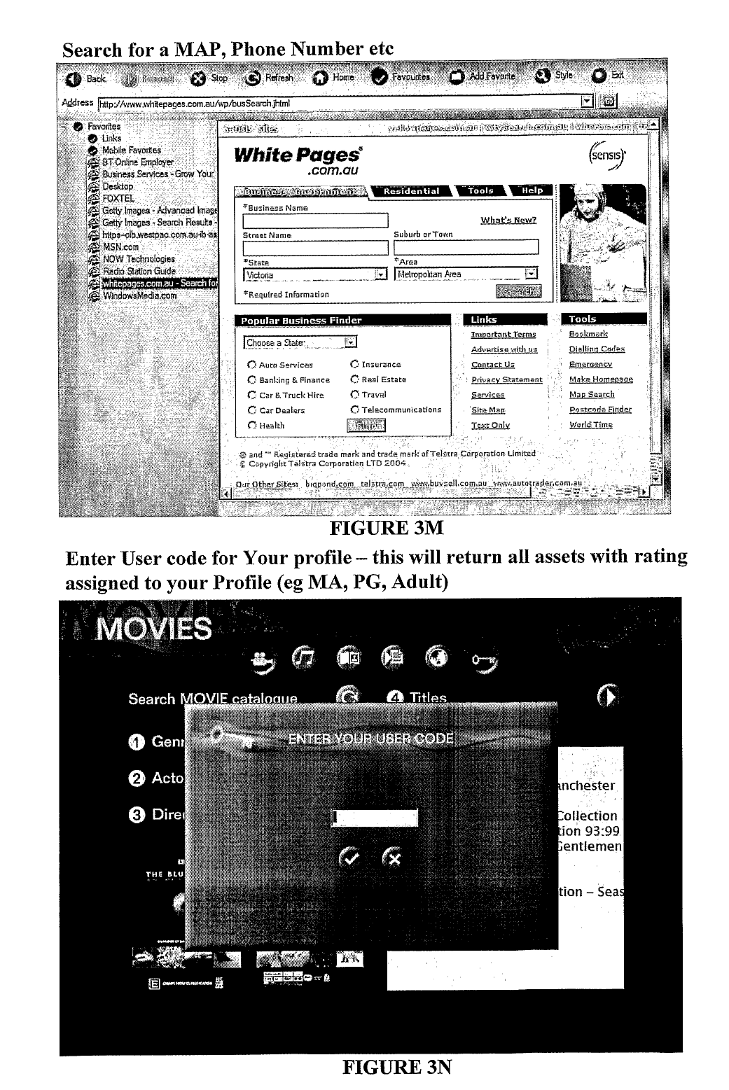

FIGS. 3A-N are screenshots of managing content stored on the server 104 based on the associated metadata. FIG. 3A illustrates that content stored in the server 104 can be catalogued as movies, music, photos, Internet content and playlists. In FIGS. 3B-D, movie content can be managed by all available titles, genre, actor, director and title. Poster art images for movies can also be displayed. Music content can be managed by all available titles, genre, artist, album title and track title, as depicted in FIGS. 3E-H. Cover art images for albums can also be displayed. FIGS. 31-J illustrate that photos can be catalogued by genre, photo album title and individual photo title. Stored web links and Internet search engines can also be catalogued, as illustrated in FIGS. 3L-M. FIGS. 3A depicts a security icon/button that can be used to set and administer security settings for users, and FIG. 3N illustrates use of a user code for secure management of stored content.

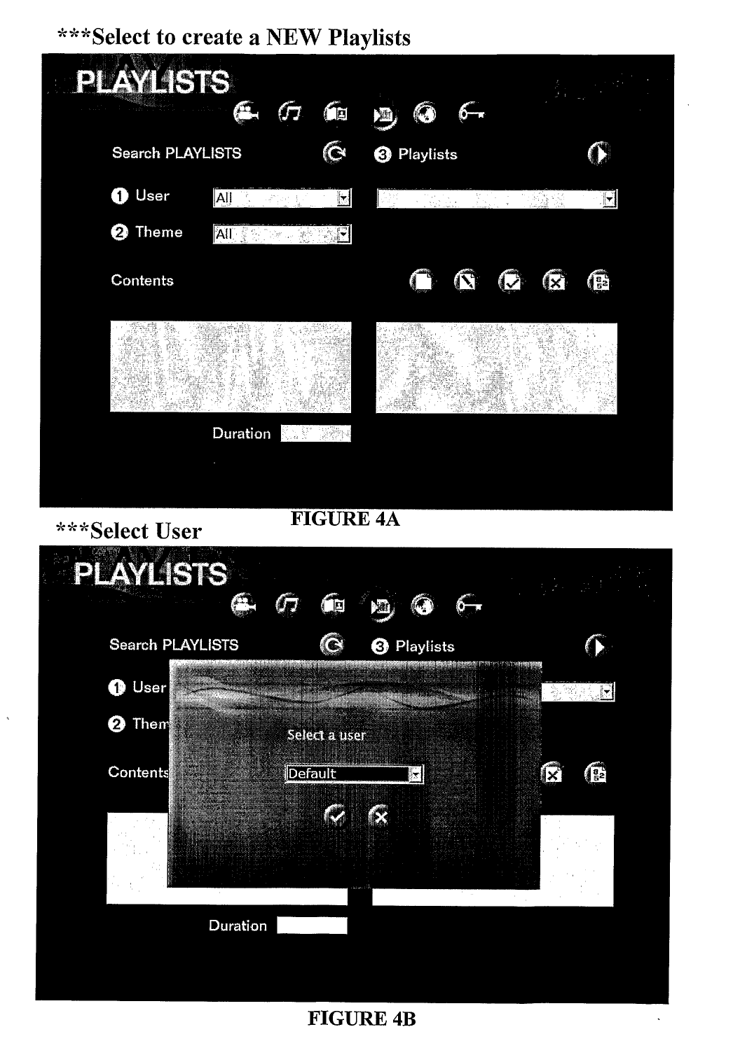

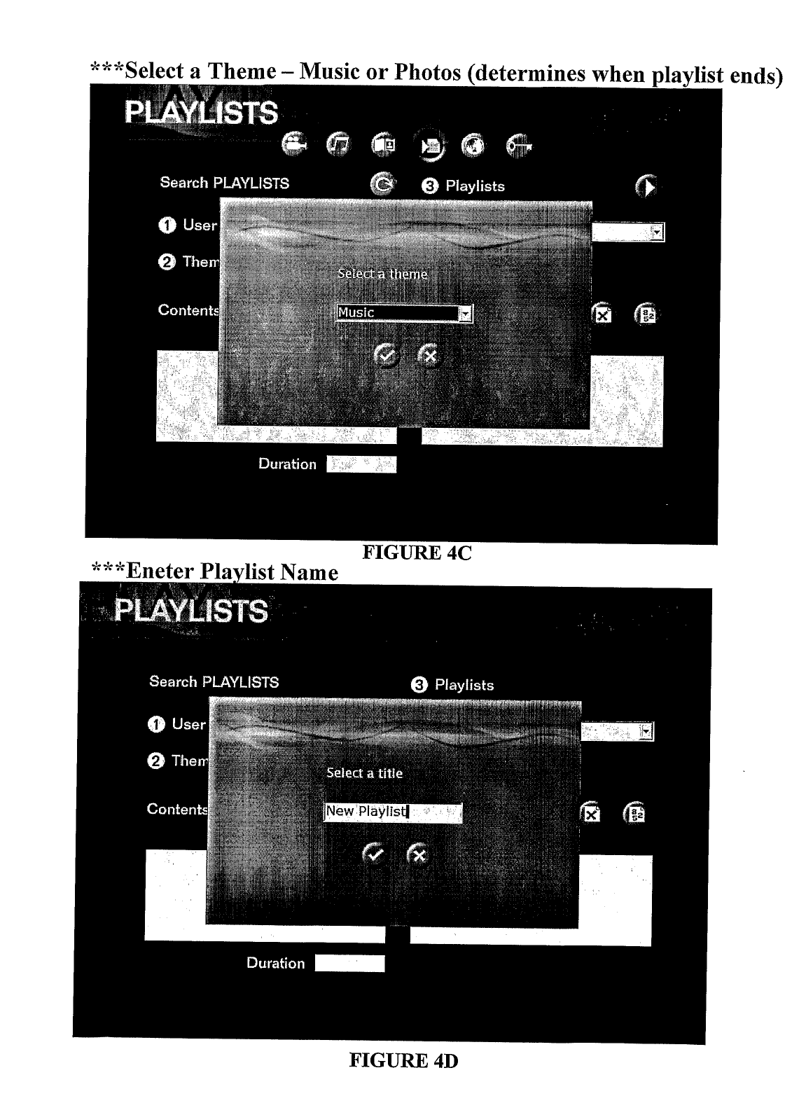

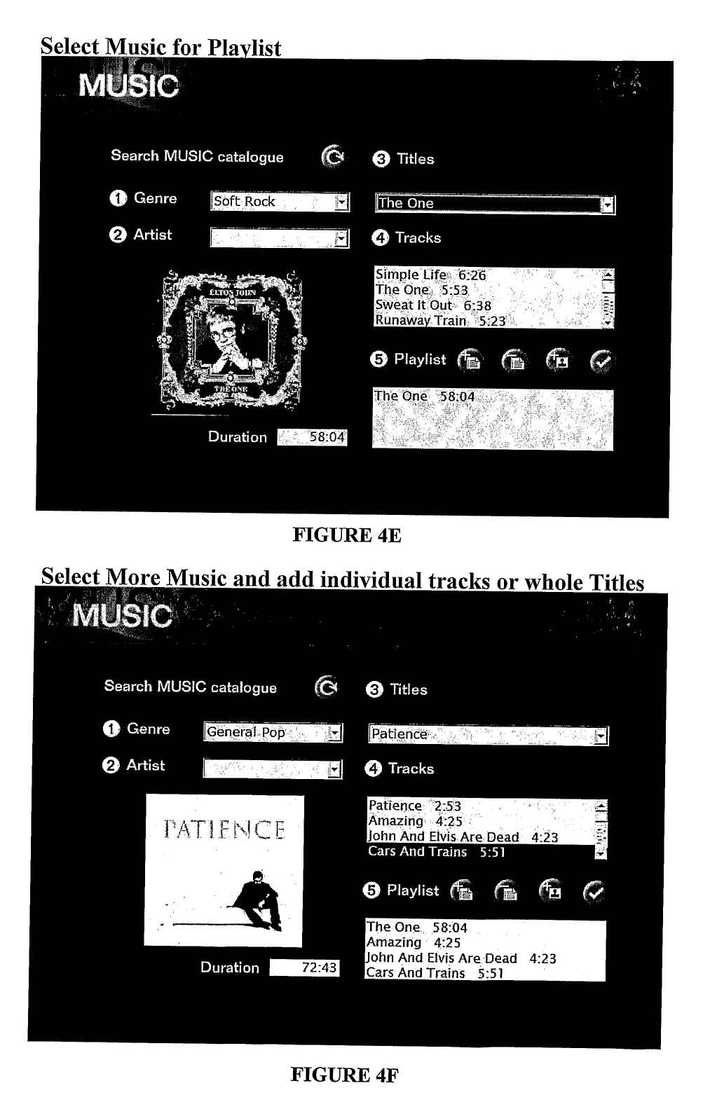

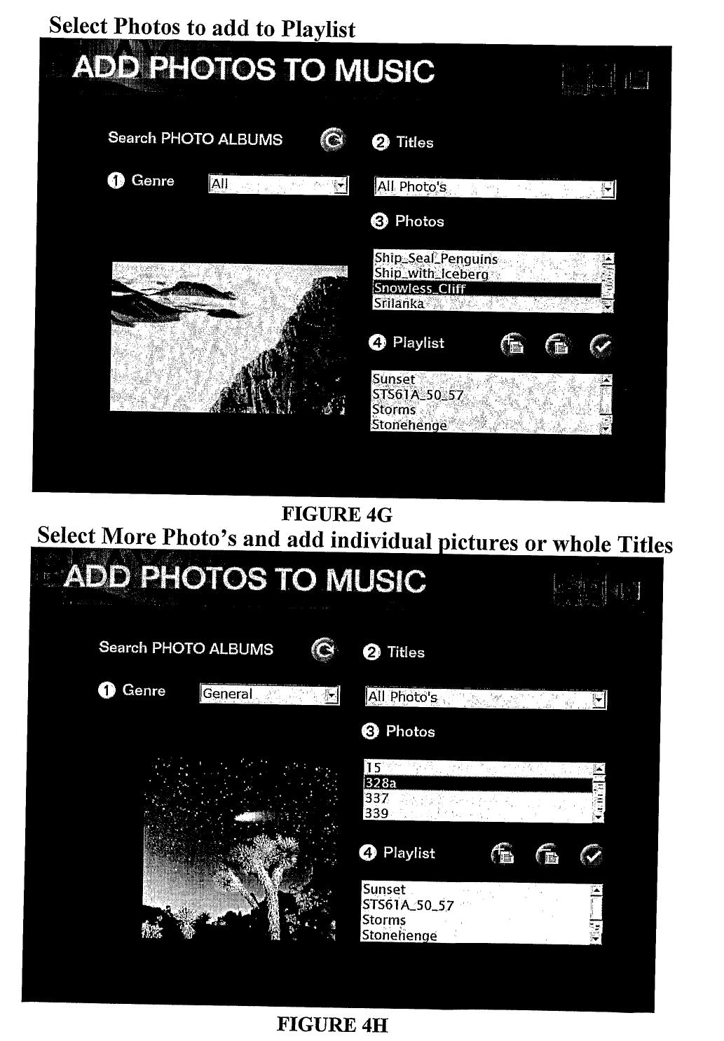

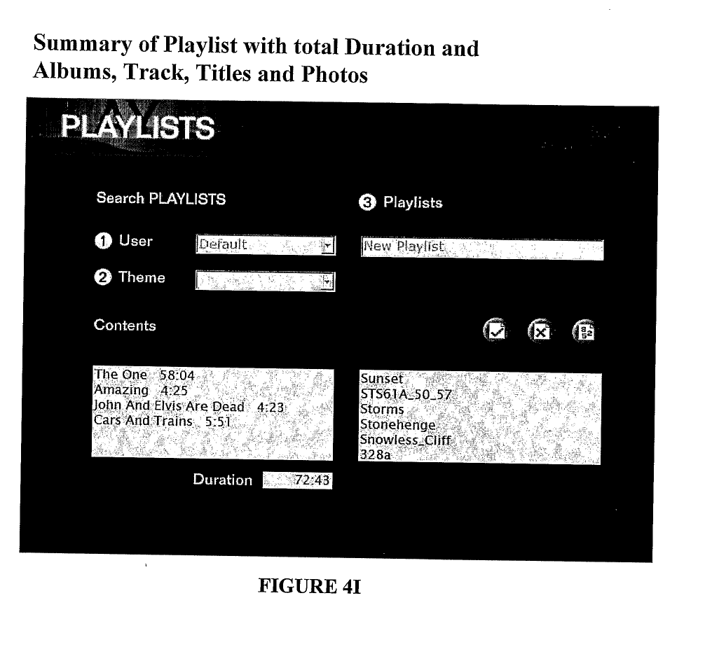

FIGS. 3K and 4A-I are screenshots illustrating the creation of playlists of content stored on the server 104. The playlists can be created using the music, photo or playlist buttons illustrated in FIG. 3A. Mixes of different types of content, such as a slideshow of photos accompanied by music tracks, can be created for playback or rendering on the playback devices 124, 126, 128, 130 via the clients 108. Playlists of stored music tracks can be created using themes, genre, artist and title of stored audio content, as depicted in FIGS. 4A-F. FIGS. 4G-H depict that stored digital photos can be previewed and selected to accompany playlists of music tracks. FIG. 4I is a playlist summary which includes, for example, titles of individual music tracks and photos, total duration of playlists. The system software is operable to generate playlists of combinations of movies, music and photos, and to control transitions between different types of content such as fade-ins and fade-outs of music and/or video between scenes, tracks, etc.

Stored content can be selectively distributed from the server 104 to playback devices 124, 126, 128, 130 by the clients 108. The system software includes a network streaming service (NSS) on the server 104 and a network streaming client (NSC) on each client 108. The NSS can access all content stored on the server 104, as well as a bank of digital television tuners and a satellite/cable descrambler card. Content is served by the NSS as packet streams which can contain any supported player media types, for example, MPEG-2, MPEG-4, WMA, WAV, WMV, DV, etc. Streams can also be encrypted to prevent “man-in-the-middle” copying attacks.

In response to user selection, the NSC on a client 108 queries the NSS for the current stream table (CST) which is a list of currently playing streams. The content of the CST can be displayed to the user which enables a NSC to join playback of that stream. An NSC can therefore join streaming of a TV channel that another NSC is using, or a channel can be added to the CST so long as a tuner is available. Alternatively, a client 108 can join a multicast of a movie or other video stream. The CST contains stream metadata describing the content type, such as “video”, “audio”, or the stream name, such as “Channel 7” or “The Fifth Element”, and other information, for example, the controlling client 108. The stream metadata is displayed as an on screen display (OSD) of information relating to the stream itself.

When a user selects streams, for example, movies, slideshows or music for playback, the NSC establishes a connection to the NSS and requests the stream to be started. For a unicast stream, the NSS creates a streaming thread that will handle transmission of stream data to the client 108 and trick play requests, for example, rewind, FF play pause, etc, from the client 108. For a connection to a unicast stream, the NSC is given the port on which to receive the multicast stream packets. After setting up the streaming thread the NSS continues listening for connection requests.

The real time protocol (RTP) and the real time streaming protocol (RTSP) are used to transport and control the playback of streams. These protocols allow a client 108 to pause and perform trick play, such as bookmark portions of content, on a media stream. The NSC will perform buffering of each stream it is connected with to account for network delays.

Each client 108 has a UPnP (Universal Plug and Play) Player Service (UPS) running that enables any compliant UPnP Control Point (CP) to issue commands to the client player 108. By combining the UPnP protocol and the digital content streaming services, an NSS can be configured to multicast streams to clients 108 that wish to participate. This facilitates synchronised playback of one or more streams to a number of clients 108. One client 108 is the designated controller of the multicast and issues commands through the server 104 to control content playback or rendering. Other clients 108 can join in or opt out at anytime during the multicast.

A client player 108 can render a number of streams independently. The core player engine controls a set of stream players based on DirectX filter graphs. These stream players are mixed together using Microsoft (trade mark) DirectX Video Mixing Render (VMR).

The web server 140 includes a virtual vault or archive database that allows users enables to remotely store selected content for archiving and safekeeping. A user can select or deselect content stored on the server 104 that is required to be remotely stored for security and insurance requirements. The vault may be used to archive or backup digital content having personal significance to the user, for example digital photos and family movies. The vault may also be used to store catalogued lists of content owned and stored on the user's local system 100, for example lists of personally acquired DVDs, CDs and MP3 audio files. The user can select or deselect content to store in the vault, and the system 100 will transfer the selected content and/or associated metadata onto the web server 142 via the Internet 140. The connection between the server 104 and the web server 142 can be a secure VPN. The archived content can be encrypted so that only authorised users can remove or view content stored in the vault.

The web server 142 can also be used to remotely update and remotely manage the hardware/software components of the system 100. The server 104 regularly requests updates from the web server 142. If an update is available, the server 104 will pull the information from the web server 142 and, at an appropriate time, the server 104 and the clients 106, 108 will be updated and verified. Recovery files can be created as backup of failed updates. The updates can make changes to both hardware and software of the system 100. In addition, each system 100 has its own operating system with recovery stored on the web server 142.

Embodiments of the present invention provide an efficient, integrated and user-friendly solution for managing unprotected and protected content in private networks.

The present invention is not limited to the embodiments that have been described and depicted, but variations and modifications may be made without departing from the scope of the present invention. For example, embodiments of the present invention are not limited to the example methods and techniques for identifying, storing and streaming different content types. It will be appreciated that embodiments of the present invention can be alternatively implemented using any and all conventional methods and techniques for identifying and/or processing content.

1. A method for managing unprotected and protected content in a private network, the method including the steps of:
receiving content;
retrieving metadata associated with the received content;
determining whether the received content is unprotected or protected based on the associated metadata;
for unprotected content, allowing the unprotected content to be selectively stored, managed and distributed in the private network based on the associated metadata;
for protected content, identifying a content protection system associated with the protected content based on the associated metadata, and performing at least one of:
displaying information to a user of the private network facilitating retrieval of one or more hardware/software components required by the associated content protection system;
retrieving the one or more required hardware/software components;
verifying that the one or more required hardware/software components are present in the private network,
before allowing the protected content to be selectively stored, managed and distributed in the private network based on the associated metadata.

2. The method according to claim 1, wherein the content includes at least one of digital video, digital audio, digital photos, digital graphics, digital animation, digital text and digital multimedia.

3. The method according to claim 1, wherein the content is received from at least one of a public network, a broadcast, a storage medium, a storage device, a media player, playback device, a satellite downlink and a mobile terminal.

4. The method according to a claim 1, wherein the metadata is retrieved from at least one of the content itself, a public network, a local database, a metadata provider and a user of the private network.

5. The method according to claim 1, wherein the content protection system associated with the protected content includes at least one of a digital rights management (DRM) system, a copy protection (CP) system, a conditional access (CA) system and technical protection measures (TPM).

6. The method according to claim 1, wherein the one or more hardware/software components required by the associated content protection system are retrieved from at least one of the content itself, a public network, a local database, a content provider, a storage medium, a storage device and a user of the private network.

7. The method according to claim 1, wherein the one or more required hardware/software components include at least one of a storage medium, a storage device, a smartcard, a dongle, an encryption key, a decryption key, a digital license, a digital certificate, a digital watermark, a media player, a product registration, a user registration, an activation code, a subscription, a digital signature, a device ID and a user ID.

8. The method according to claim 1, wherein the private network is at least one of an Intranet, a cellular network, a local area network (LAN), a virtual private network (VPN), a personal area network (PAN) and an authorised domain (AD).

9. The method according to claim 1, wherein the private network is wired and/or wireless.

10. A processor program product stored in a processor readable storage device, the processor program product having processor instructions for causing at least one processor to:
receive content;
retrieve metadata associated with the received content;
determine whether the received content is unprotected or protected based on the associated metadata;
for unprotected content, allow the unprotected content to be selectively stored, managed and distributed in the private network based on the associated metadata;
for protected content, identify a content protection system associated with the protected content based on the associated metadata, and perform at least one of:
display information to a user of the private network facilitating retrieval of one or more hardware/software components required by the associated content protection system;
retrieve the one or more required hardware/software components;
verify that the one or more required hardware/software components are present in the private network,
before the protected content is allowed to be selectively stored, managed and distributed in the private network based on the associated metadata.

11. A system for managing unprotected and protected content in a private network, the system including:
one or more processors connected to the private network;
processor instructions for causing the one or more processors to:
receive content;
retrieve metadata associated with the received content;
determine whether the received content is unprotected or protected based on the associated metadata;
for unprotected content, allow the unprotected content to be selectively stored, managed and distributed in the private network based on the associated metadata;
for protected content, identify a content protection system associated with the protected content based on the associated metadata, and perform at least one of:
display information to a user of the private network facilitating retrieval of one or more hardware/software components required by the associated content protection system;
retrieve the one or more required hardware/software components;
verify that the one or more required hardware/software components are present in the private network,
before the protected content is allowed to be selectively stored, managed and distributed in the private network based on the associated metadata; and
one or more processor readable storage devices connected to the one or more processors to store the processor instructions, the received content, the associated metadata and the one or more hardware/software components required by the associated content protection system.

12. The system according to claim 11, wherein the one or more storage devices include at least one physical media storage device configured to physically store one or more removable storage media required by the associated content protection system.

13. The system according to claim 12, wherein the at least one physical storage device is configured to further store one or more software components associated with the one or more physically stored removable storage media.

14.-15. (canceled)
